(19) United States
(12) Patent Application Publication
(10) Pub. No.: US 2004/0207221 A1
(43) Pub. Date: Oct. 21, 2004

(54) Load transfer plate

(76) Inventor: George Hockenhull, Petrolia (CA)

Correspondence Address: PEARNE & GORDON LLP, 1801 EAST 9TH STREET, SUITE 1200, CLEVELAND, OH, 44114-3108, US

(21) Appl. No.: 10/811,099

(22) Filed: Mar. 26, 2004

(30) Foreign Application Priority Data
Mar. 28, 2003 (CA) 2,424,244

(51) Int. Cl. B66C 1/10

(52) U.S. Cl. 294/82.1

(57) ABSTRACT

A load transfer plate is used in transferring loads from one lifting device to another. It comprises a plate having sufficient tensile strength to support a rated load. The plate has at least three connection points spaced around its perimeter for connecting the plate to a load or a lifting device.

The present invention relates to the field of rigging, and specifically provides a novel transfer link for use with chains or slings, to assist in transferring loads from one lifting apparatus to another.

Items such as cargo being loaded onto a ship, or construction supplies being hauled by crane to an upper floor of a building under construction are often transferred from one lifting apparatus to another. Lifting the item with the first apparatus involves positioning a sling on the item or attaching chains to the item (depending on what is being lifted), and then fastening the ends of the sling, or the ends of the chain, to a master link, which may be a ring large enough to have several shackles fastened around it. The master link is then slipped onto a hook from the lifting apparatus. To transfer the load to a second lifting apparatus, the hook from the second apparatus may be passed through the master link, and the weight of the load is eased onto the hook of the second apparatus. An example of a master link that is appropriate for this type of load transfer is shown in U.S. Pat. No. 3,299,628, or U.S. Pat. No. 4,941,698, or U.S. Pat. No. 569,448, or U.S. Pat. No. 4,068,467. A significant difficulty and hazard that arises with use of existing master links is that when the second hook is inserted, it may jam the first hook, making it difficult to remove the first hook, or creating a situation wherein the first hook may fly out suddenly as the weight of the load shifts.

The present invention provides a simple yet novel master link, in the form of a load transfer plate to which at least three shackles can be attached. The first shackle is intended to be attached to the load, and therefore must be large enough and strong enough to accommodate several chain or sling attachments, be they other shackles, hooks, clips, or the like. The second and third shackles of the load transfer plate are each large enough to easily accommodate the hook of a lifting device.

In a broad aspect, then, the present invention relates to a load transfer plate for use in transferring loads from one lifting device to another comprising a plate having sufficient tensile strength to support a rated load, having at least three connection points spaced around its perimeter for connecting said plate to a load or a lifting device.

In drawings that illustrate the present invention by way of example:

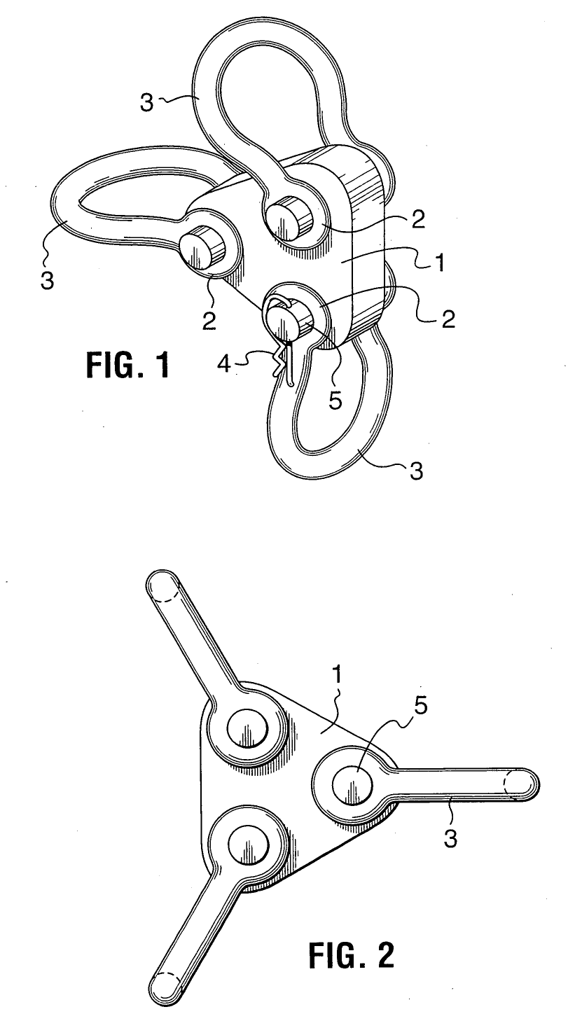

FIG. 1 is a perspective view of a transfer plate according to the present invention, with three shackles attached thereto;

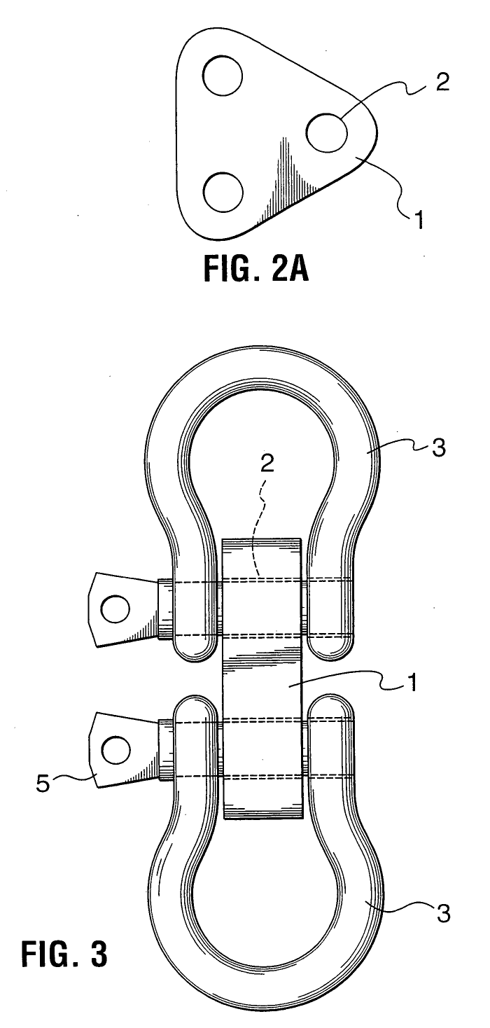

FIG. 2 is a front view of the transfer plate and shackles of FIG. 1;

FIG. 2a is a front view of the transfer plate only of FIG. 1;

FIG. 3 is a side view of the transfer plate and shackles of FIG. 1;

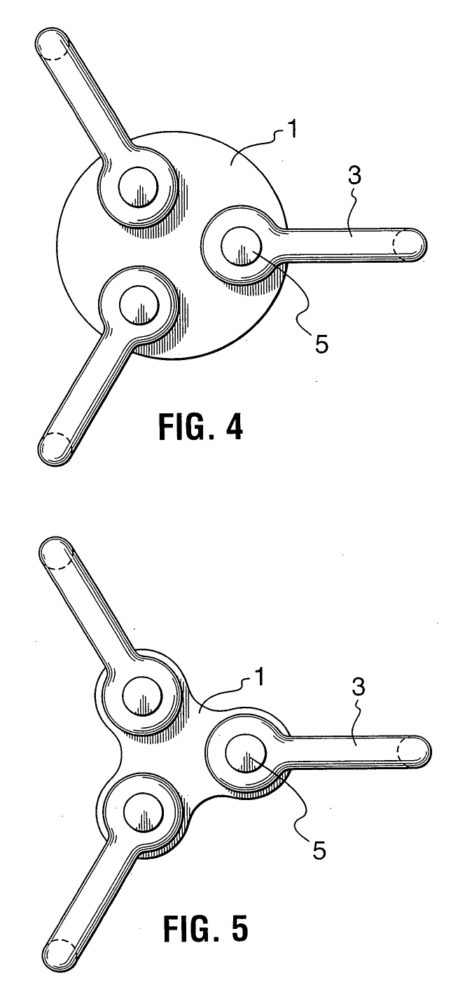

FIG. 4 is a front view of a first alternate embodiment of the transfer plate of the present invention, with shackles attached;

FIG. 5 is a front view of a second alternate embodiment of a transfer plate of the present invention, with shackles attached thereto.

Referring now to FIGS. 1, 2, 2a and 3, the present invention provides a plate 1 that may be triangular, as shown in FIGS. 1 and 2 and 2a, but may, as shown in FIGS. 4 and 5, be any other desired shape, such as circular (FIG. 4) or tri-lobed (FIG. 5). If triangular, the corners will preferably be rounded, as shown in FIGS. 2 and 2a.

The plate has three apertures preferably evenly spaced around its perimeter—in the case of a triangular plate such as those shown in FIGS. 1 to 3, the apertures are in the corners of the triangle—and shackles 3 or other suitable load carrying connectors, are fastened by conventional means through each aperture. The shackles may be any suitable conventional type, and will preferably be provided with means such as a locking pin 4 (only one of which is illustrated) to prevent them from accidental detachment from the transfer plate. The shackles 3 as well as the transfer plate 1 itself should be load rated, utilizing standard safety factors, to carry specified loads, such as 10 tons, 20 tons, or more.

Though any manufacturers' shackles can be used, shackles typically follow a standard and hence the diameter of the apertures and thickness of the transfer plate will be specifically sized for specific size of shackles. For instance, a ⅞ inch shackle has an opening width of 1 7/16 inches and hence the thickness of the transfer plate will be 1⅜ inches so that the shackle will not slide. The load bearing pins for the ⅞ inch shackle are just under 1 inch in diameter and hence the diameter of the apertures will be made just larger than 1 inch so that the load bearing shackle pin can easily be inserted and removed, if required.

The shackles that are used can be any shackle that will match the rating of the device. For instance, anchor shackles or bolt type shackles, or sling saver shackles are all options.

The material for the device may be any metal though the preference is tool steel. Depending on the capacity, aluminum may be a possibility as well as any other metals as long as the change in materials does not degrade the capacity of the specific device. In other words, the dimensions, the type of shackles, and the material that is used are all matched so that at a rated capacity the device is safe for use.

There are many ways of producing the plate of the present invention. The simplest is to cast the plate by producing a mold and then casting it using the appropriate materials. The advantage of this process is that for mass production the cost will be low and there can be an economical use of materials in that the simplest or most efficient shape can be used.

The plate 1 may be manufactured using round or triangular bar stock, cutting off the appropriate length, and drilling three holes. The drilling of holes 2 may be done prior to the cut off using a gun drill operation, in which case very deep holes may be drilled or they may be done singly by cutting off the part and drilling the holes later in a drill press or similar type operation.

Another option for manufacturing is to use a milling machine and cutting the part completely out of a block of steel. This is the most costly but is effective when manufacturing small quantities as there is greater versatility in size and shape that can be achieved. It will be appreciated, then, that any other shape desired may be used, such as square, cruciate, or star-shaped. Also, more shackles may be utilized, since with some kinds of load, more than one shackle may be required to securely rig the load for lifting.

In use, the shackles are securely attached to the load transfer plate. The sling or chains form the load to be lifted are then connected to one of the shackles (or more, if four or more shackles are provided on the plate). The hook (or other load lifting connection device) from the first lifting apparatus is then hooked onto another of the shackles, and the load is lifted and moved as required. After the load had been moved into proximity with the other lifting device, which may be for instance a second crane, or a chain fall, the hook (or other connecting device) from the second lifting is connected to the remaining shackle on the connecting plate. The second lifting device is then activated, and the load is carefully lifted free of the first lifting device. It will be observed, then, that at no time are the hooks from the first and second devices in contact with each other, so they can't join, or cause each other to fly out. Moreover, the load is transferred without shock or undue stress to either lifting device.

What is claimed is:

1. A load transfer plate for use in transferring loads from one lifting device to another comprising a plate having sufficient tensile strength to support a rated load, having at least three connection points spaced around its perimeter for connecting said plate to a load or a lifting device.

2. A load transfer plate as claimed in claim 1, wherein said connection points are apertures in said plate for the attachment of said plate to shackles.

3. A load transfer plate as claimed in claim 2, further comprising a shackle connected to said load transfer plate at each said connection point, said shackles being rated to carry said load.

4. A load transfer plate as claimed in claim 2, wherein said plate is triangular, and said apertures are located in the three corners of said plate.

5. A load transfer plate as claimed in claim 4, wherein said plate has rounded corners.

6. A load transfer plate as claimed in claim 2, wherein said plate is circular, and said apertures are regularly spaced around said plate.

7. A load transfer plate as claimed in claim 2, wherein said plate is tri-lobed, and said apertures are located in the three lobes of said plate.

8. A load transfer plate as claimed in claim 5, wherein said plate is fabricated by cutting from a bar of material.

9. A load transfer plate claimed in claim 1, wherein said plate is made from steel.
